(19) United States
(12) Patent Application Publication
(10) Pub. No.: US 2009/0110062 A1
(43) Pub. Date: Apr. 30, 2009

(54) OPTIMAL HEEGARD-BERGER CODING SCHEMES

(75) Inventors: Oscar Chi Lim AU, Hong Kong (CN); Xiaopeng FAN, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/929,214

(22) Filed: Oct. 30, 2007

(51) Int. Cl. H04N 7/32

(52) U.S. Cl. 375/240.03; 375/240.16; 375/240.25; 375/E07.243

(57) ABSTRACT

Optimal Heegard-Berger coding methods, devices, and systems are provided based on the disclosed coding schemes. The disclosed schemes facilitate decoding even in the absence of side information, with lower coding complexity than conventional Wyner-Ziv based distributed coding techniques. The disclosed details enable various refinements and modifications according to system design considerations.

### TECHNICAL FIELD

The subject disclosure relates to coding and decoding, and more specifically to methods, devices and systems for performing Heegard-Berger coding and decoding schemes.

### BACKGROUND

In the 1970s, Slepian and Wolf proved that distributed correlated source lossless encoding can be performed separately with no rate increase over joint encoding. Wyner and Ziv extended one case of this problem (e.g., encoding with side information only available at decoder) to lossy coding and established a rate distortion function. A zero rate loss from joint compression to separate compression for quadratic Gaussian case was also proven. For many other sources, this coding efficiency loss was also proven to be bounded.

To realize Distributed Source Coding (DSC) system, many approaches have been proposed, including coset and near optimal channel codes such as TURBO and Low Density Parity Check (LDPC). In those approaches, the key idea is to imagine a virtual channel between source and side information. Parity bits of source symbols are generated and sent to the decoder as a bitstream, which can be used to estimate the original source symbol while discarding systematic bits. Thus the decoder regards the side information as a noisy version of systematic bits and corrects back to the original source bits, with the help of parity bits received from encoder. As a result, the DSC problem can be essentially converted into a channel coding problem, with error correction codes employed to correct channel errors.

By introducing DSC to video coding, a prediction frame as side information for a current frame is no longer needed at an encoder according to the Wyner-Ziv (WZ) theorem. Therefore, in a WZ video coding system, each frame is coded separately, while prediction frames are only generated at the decoder. One advantage that results is that this allows for relatively low complexity encoders, since motion estimation processes can be shifted to the decoder.

However, conventional distributed video coding schemes based on a WZ coder can still require significant complexity at the encoder and decoder. This follows from the fact that such WZ coder implementations require binarization and channel coding (e.g., Turbo, LDPC, etc.), which can substantially increase encoder complexity due to the significant amount of bit operations required. Moreover, at the decoder side, significant computational complexity is required due to the channel code decoder. As a result, such implementations are typically designed for set of assumptions about the quality of side information, which can be relatively inflexible in terms of complexity scalability, and which can limit the efficacy of minimally capable decoding devices.

While WZ coding schemes can achieve good compression, for practical non-stationary sources such as video, it is difficult to decide on a bit rate at the encoder. This results because after quantization, the minimum bit rate (e.g., the conditional entropy) depends on the side information, which is not available at the encoder by definition and thus can be better or worse than anticipated at the encoder. As a result, degraded side information can cause decoding failure or require redundant bitrate, while upgraded side information results in bit stream redundancy.

Common solutions to this problem attempt to fix the distortion and try find optimal rate for uncertain side information. However, such solutions are typically difficult to design, result in highly complex solutions, or can even be impossible in some instances.

For example, one solution is to introduce a feedback channel, where the encoder encodes the parity bits and sends them to the decoder in a recursive manner. The decoder will then send the symbol back to the encoder on successful decoding. However, this feedback channel solution is restricted to decoding applications where such feedback is possible (e.g., online applications). Moreover, the feedback channel results in an encoder that is not strictly distributed. More importantly, it increases the delay latency by the sum of the decoding delay and the feedback delay.

Another solution is to allow the encoder to estimate the correlation between the source and the prediction. However, this estimation scheme cannot be used in a strict distributed video coding application in which the encoder cannot access the side information at all (e.g., in a camera array). In other applications, the side information may be degraded or unreliable such as in distributed compression applications in a wireless sensor network, where the side information is acquired over an unreliable channel (e.g., a wireless channel subject to noise and interference). Heegard and Berger extended this scenario to the situation where side information is absent at the decoder. In still other applications, rate redundancy and decoding failure problems persist, because the estimation scheme is not perfect or sophisticated enough while preserving the advantageously low complexity of distributed video coding.

As a result, further improvements in distributed source coding are desired which keep the decoder complexity low, while allowing for degraded, uncertain, or missing side information at the decoder.

The above-described deficiencies are merely intended to provide an overview of some of the problems encountered in implementing distributed source coding, and are not intended to be exhaustive. Other problems with the state of the art may become further apparent upon review of the description of the various non-limiting embodiments of the invention that follows.

### SUMMARY

In consideration of the above-described deficiencies of the state of the art, various non-limiting embodiments of the invention provide optimal Heegard-Berger coding methods, devices, and systems. By eliminating the feedback channel and fixing the rate so that distortion can depend on the quality of the side information, the invention provides coding schemes that facilitate codeword decoding even in the absence of side information. Advantageously, where reliable side information is available at the decoder, improved image decoding is possible according to various embodiments.

According to exemplary non-limiting embodiments, the invention provides Heegard-Berger (HB) video coding schemes with two level decoding at the decoder. In various non-limiting embodiments a coarse version frame is first reconstructed, which facilitates finding a prediction, which in turn can be used to reconstruct a fine version frame.

According to further non-limiting embodiments the invention provides a coder that cascades lossy coding with post processing linear minimum mean square error (LMMSE) estimation. According to various embodiments, the invention advantageously provides optimal coding solutions while maintaining minimal complexity.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The Heegard-Berger coding devices, systems, and methods are further described with reference to the accompanying drawings in which:

FIG. 1 illustrates an exemplary non-limiting HB coding and decoding system in which various embodiments of the present invention may be practiced;

FIG. 2 illustrates an exemplary non-limiting block diagram of a HB coding and decoding system according to various non-limiting embodiments of the present invention;

FIG. 3 illustrates an exemplary non-limiting block diagram of a HB coding and decoding system according to various non-limiting embodiments of the present invention;

FIG. 4 illustrates an exemplary non-limiting block diagram of a method for HB coding and decoding according to one aspect of the present invention;

FIG. 5a illustrates an exemplary high-level block diagram of a system for coding and decoding according to one aspect of the present invention;

FIG. 5b illustrates an exemplary non-limiting block diagram of an apparatus for coding or decoding according to one aspect of the present invention;

FIGS. 6a-b illustrate block diagrams of exemplary non-limiting embodiments of video coding and decoding systems suitable for practicing the present invention;

FIG. 7 depicts comparative Rate-Distortion (RD) performance for Quarter Common Intermediate Format (QCIF) input video sequence (‘Salesman’) according to particular non-limiting embodiments of the present invention;

FIG. 8 depicts comparative RD performance for QCIF input video sequence (‘Foreman’) according to particular non-limiting embodiments of the present invention;

FIG. 9 depicts comparative RD performance for QCIF input video sequence (‘Mobile’) according to particular non-limiting embodiments of the present invention;

FIG. 10 depicts comparative RD performance for QCIF input video sequence (‘Paris’) according to particular non-limiting embodiments of the present invention;

FIG. 11 is a block diagram representing an exemplary non-limiting networked environment in which the present invention may be implemented; and

FIG. 12 is a block diagram representing an exemplary non-limiting computing system or operating environment in which the present invention may be implemented.

### DETAILED DESCRIPTION

### Overview

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments can be practiced without these specific details. In other instances, well-known structures and devices are shown in block diagram form in order to facilitate describing one or more embodiments.

Thus, the simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the invention in a simplified form as a prelude to the more detailed description of these and various other embodiments of the invention that follow. It should be apparent that the teaching herein may be embodied in a wide variety of forms and that any specific structure and/or function disclosed herein is merely representative. Based on the teachings herein one skilled in the art should appreciate that an aspect disclosed herein may be implemented independently of any other aspects and that two or more of these aspects may be combined in various ways. For example, an apparatus may be implemented and/or a method practiced using any number of the aspects set forth herein. In addition, an apparatus may be implemented and/or a method practiced using other structure and/or functionality in addition to or other than one or more of the aspects set forth herein. Thus, it should be understood that various modifications may be made by one skilled in the relevant art without departing from the intent of the disclosed invention. Accordingly, it is the intent to include within the scope of the invention those modifications, substitutions, and variations as may come to those skilled in the art based on the teachings herein.

As described above, further improvements in distributed source coding are desired which keep the decoder complexity low, while allowing for degraded, uncertain, or missing side information at the decoder.

In consideration of the foregoing and related ends, in accordance with exemplary non-limiting embodiments, the invention provides optimal HB coding methods, devices, and systems. By eliminating the feedback channel and fixing the rate so that distortion can depend on the quality of the side information, the invention provides coding schemes that facilitate codeword decoding even in the absence of side information. According to exemplary non-limiting embodiments, the invention provides HB video coding scheme with two level decoding at the decoder. In various non-limiting embodiments a coarse version frame is first reconstructed, which can be used to find a prediction, this in turn is used to reconstruct a fine version frame. Advantageously, where reliable side information is available at the decoder, improved image decoding is possible according to various embodiments.

According to further non-limiting embodiments the invention provides a coder that cascades a lossy coding with a post processing linear minimum mean square error (LMMSE) estimator. According to various embodiments, the invention advantageously provides optimal coding solutions while maintaining minimal complexity.

In order to provide a better understanding of the description of the invention with reference to the figures identified below, the following abbreviations are used herein (e.g., Motion Compensation (MC); Motion Estimation (ME); Motion Estimation and Motion Compensation (ME&MC); Motion Vectors (MVs); Quantization/Dequantization (Q/Q⁻¹); and delay element (Z⁻¹)). In addition, various embodiments are described with respect to video coding techniques. Thus terminology such as “frames” or other application specific terminology implying an innate data structure or segmentation pattern may be used for purposes of explanation and not limitation of the claims appended hereto. For the avoidance of doubt, except where the clear context of the claims is to the contrary, it is intended that the term “frames” or other application specific terminology is interchangeable with the more generic terms such as “data” and “information,” without limiting the hereto appended claims to any innate data structure, segmentation pattern, or otherwise such application specific terminology.

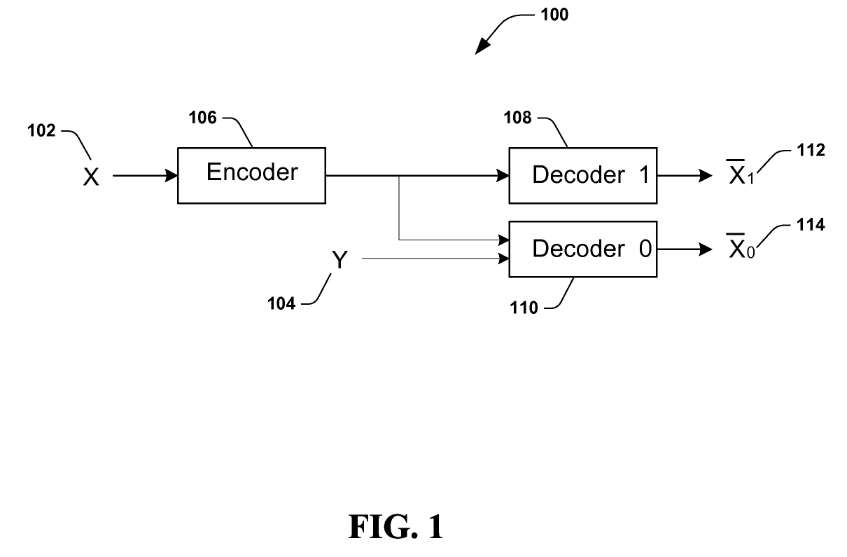

FIG. 1 illustrates an exemplary non-limiting HB coding and decoding system in which various embodiments of the present invention can be practiced. One advantageous difference between HB coders and WZ coders is that HB coders can decode either with or without side information. Encoder 106 encodes X 102 into a bitstream. At the decoder side (108, 110), if side information Y 104 is not available, a coarse version reconstruction \hat{X}₁ 112 can be decoded 108. If side information Y 104 is available, a fine reconstruction \hat{X}₀ 114 can be obtained. For example, in quadratic Gaussian case, e.g., Y=X+N, it has been proven that for all D₁≦σ_{X}²:

R_{HB}(D)=½log⁺[σ_{X}²σ_{N}²/(D₀(D₁+σ_{N}²))] (1)

where log⁺(x)=max(log(x), 0), and D₁, D₀ denote respectively the distortion of \hat{X}₁ 112 and \hat{X}₀ 114 from X 104, and where X 102, Y 104, and N denote source, side information and noise respectively.

Generally R_{HB}(D₁,D₀)≧R_{WZ}(D₀), which is the rate cost to achieve the flexibility to reconstruct a coarse version without side information available. However, there are also some cases that R_{HB}(D₁,D₀)=R_{WZ}(D₀). In actuality, as is shown below in various embodiments of the invention, the HB coder can outperform the WZ coder, because it can benefit from better side information Y 104.

Heegard-Berger Distributed Coding

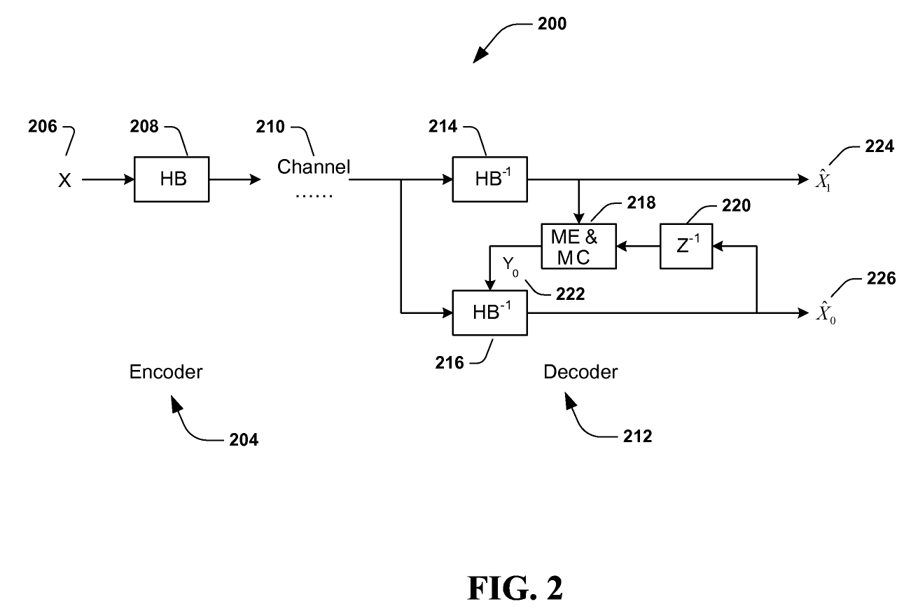

FIG. 2 illustrates an exemplary non-limiting block diagram of a HB coding and decoding system according to various non-limiting embodiments of the present invention, in which HB frames can be used as interframes instead of P frames (e.g., prediction frames). In various embodiments, each frame X 206 can be coded by a frame-HB encoder 204 at 208 without motion estimation and intra prediction and sent to the decoder 212. Additionally at the decoder side 212, a coarse version reconstruction image \hat{X}₁ 224 can be first decoded by HB decoder 1 214. The decoding at this point provides a reduced complexity decoder similar to traditional I frame (e.g., intra-coded frame) decoder. For a more powerful decoder, according to various embodiments, the invention can use the coarse version image reconstruction \hat{X}₁ 224 (e.g., as the source frame X) and can perform motion search (e.g., at 218) for the last reconstruction frame and find a prediction Y 222 for the current frame. As a result, the invention can advantageously reconstruct a fine version image \hat{X}₀ 226 in HB decoder 0 216.

Because motion compensation 218 at decoder 212 can only partially remove the temporal redundancy, according to various non-limiting embodiments of the invention, Discrete Cosine Transform (DCT) can also be used to exploit spatial redundancy.

According to various non-limiting embodiments, the invention provides a practical HB coding scheme that can cascade a lossy coder and a post processing linear minimum mean square error (LMMSE) estimator. In one aspect, the invention can be described in the context of the quadratic Gaussian case. The quadratic Gaussian case is important for video compression, because the residue frame is usually assumed to satisfy Gaussian distribution, and video distortion measure Peak Signal to Noise Ratio (PSNR) is equivalent to Mean Square Error (MSE). Furthermore, the description of the invention in the context of the quadratic Gaussian case is reasonable, because after DCT transform, the distribution of coefficients can be considered as roughly Gaussian.

Accordingly, various non-limiting embodiments of the invention can be described assuming that the distribution of DCT coefficient is Gaussian and Y=X+N, where X, Y, and N denote source, side information and noise respectively, as described above. In other words, X is the DCT coefficient we want to code, Y is the coefficient from the motion compensated block, and N is the residue between X and Y. Similar to multiple Description Coding (MDC) where a single media stream is fragmented into multiple independent sub streams referred to as descriptions, the packets of which are routed over multiple paths in parallel, various HB coding schemes can be classified as follows:
A) No excess rate case: R_{HB}(D₁,D₀)=R_{WZ}(D₀). Where R_{WZ}(D₀) denotes the rate of a WZ coder to achieve distortion Do.
B) No excess marginal rate case: R_{HB}(D₁,D₀)=R_{X}(D₁). Where all bit rate can be used to improve the quality of \hat{X}₁, and the quality gain from \hat{X}₁ to \hat{X}₀ results from better quality side information Y.
C) General case: Situations between case ‘A’ and case ‘B’ are general cases in which distortion D₁ and D₀ are balanced.

Among these three cases, assuming a fixed bit rate, class ‘A’ can be shown to provide lowest distortion (best performance) when side information is available, but the highest distortion when side information not available. Class ‘B’ performs oppositely from class ‘A’, and class ‘C’ shows performance between that of class ‘A’ and class ‘B’.

Class ‘A’ (e.g., a WZ coder) as described above is widely used in distributed video coding. However, as described above, the performance will suffer with degraded side information. As a result, various embodiments of the invention facilitate using good quality \hat{X}₁ (e.g., coarse version image reconstruction) to improve side information Y after motion estimation. This can be seen in the following explanation. For the quadratic Gaussian case, if R_{HB}(D₀,D₁)=R_{WZ}(D₀), then D₁≧σ_{X}² as follows. Given that the RD function for a HB coder and a WZ coder can be written respectively as:

$$\begin{matrix}{R}_{HB} ( D ) = \frac{1}{2} {log}^{+} \frac{{σ}_{X}^{2} {σ}_{N}^{2}}{{D}_{0} ( min ( {D}_{1} , {σ}_{X}^{2} ) + {σ}_{N}^{2} )} & ( 2 ) \\ {R}_{WZ} ( {D}_{0} ) = \frac{1}{2} {log}^{+} \frac{{σ}_{X}^{2} {σ}_{N}^{2}}{( {σ}_{X}^{2} + {σ}_{N}^{2} ) {D}_{0}} & ( 3 )\end{matrix}$$

Comparing Eqn. 2 and Eqn. 3 immediately yields min(D₁, σ_{X}²)=σ_{X}² or D₁≧σ_{X}².

As a result, it can be seen that Signal-to-Noise Ratio (SNR) of \hat{X}₁ is not more than 0 decibel (dB), such that the coarse version image reconstruction \hat{X}₁ is suitable for improving side information Y.

Class ‘C’ can be implemented by a successive refinement scheme, where the source frame X is first encoded to get \hat{X}₁ at the decoder side, and then X is encoded to get \hat{X}₀ at the decoder side given side information Y at the decoder and \hat{X}₁ at both the encoder and the decoder.

According to various non-limiting embodiments of the invention class ‘B’ can be implemented by cascading a lossy coder and a LMMSE estimation module at the decoder: \hat{X}₀=E(X|\hat{X}ₗ, Y). As a result, more bits can be used to improve the quality of \hat{X}₁ so as to advantageously improve side information Y, in turn resulting in improved \hat{X}₀, according to various embodiments of the invention. Conversely, fewer bits used to improve the quality for \hat{X}₁ will degrade side information Y, which in turn will degrade the quality of \hat{X}₀. For purposes of explanation and not limitation, the class ‘B’ is chosen to illustrate the concepts and advantages of the HB coding schemes of the present invention.

It should be appreciated by one skilled in the art that many variations are possible without deviating from the spirit of the present invention. For example, it is expected that the HB coding schemes can provide improved performance with the class ‘C’ successive refinement schemes can be implemented at the encoder 204, where side information Y is available at the decoder and \hat{X}₁ is available at both the encoder and the decoder as described above. Thus the following description of the class ‘B’ coding scheme should not limit the scope of the claims appended hereto.

As a result, according to various non-limiting embodiments, the invention provides optimal schemes (e.g., class ‘B’) for the quadratic Gaussian case as shown in the following. In the quadratic Gaussian case, if R_{HB}(D₀,D₁)=R_{X}(D₁), then

$${D}_{0} = \frac{{D}_{1} {σ}_{N}^{2}}{{D}_{1} + {σ}_{N}^{2}}$$

as follows. Comparing Eqn. 1 with R_{X}(D₁)=½log⁺(σ_{X}²/D₁) yields

$${D}_{0} = \frac{{D}_{1} {σ}_{N}^{2}}{{D}_{1} + {σ}_{N}^{2}} ,$$

which is just the LMMSE estimation noise \hat{X}₀=E(X|\hat{X}₁,Y)

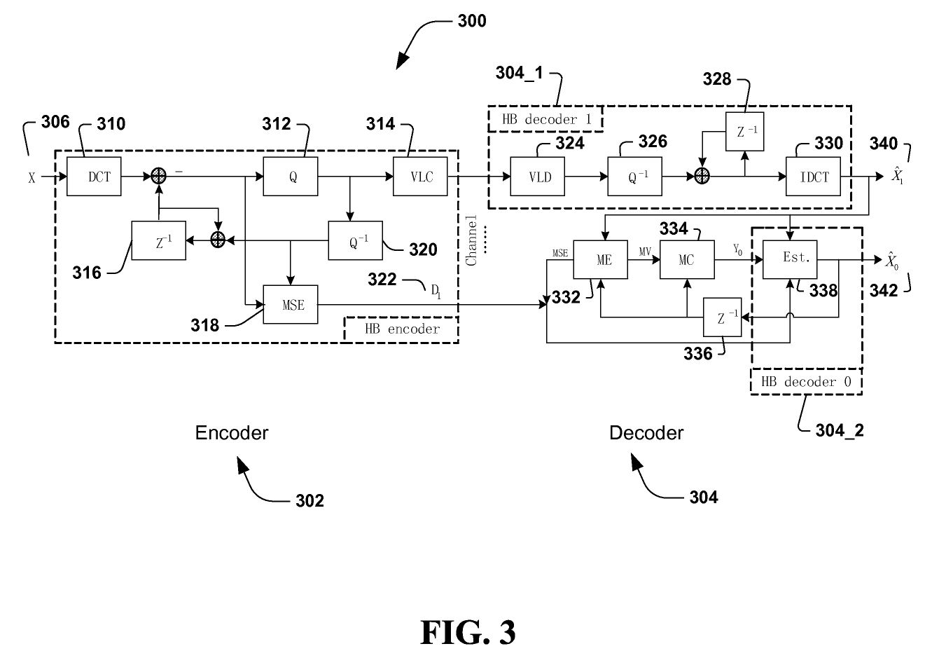

FIG. 3 illustrates an exemplary non-limiting block diagram of a HB coding and decoding system according to various non-limiting embodiments of the present invention. At the encoder side 302, an exemplary lossy coder can comprise a quantization 312 and entropy coding 314 to encode each coefficient of X 306, where \hat{X}₁ 340 is the expected reconstruction of X 306 at a decoder side 304. In addition, D₁=E[(\hat{X}₁−X)²] 322 in SNR format for every 11 macroblocks (e.g., 1 slice) can be encoded and transmitted to the decoder 304. At the decoder side 304, the first bitstream can be decoded at 304_1 to get \hat{X}₁ 340, which can then be used to perform a motion search 332 to provide side information Y after motion compensation 334, and a LMMSE estimator can be used to get \hat{X}₀ 342. As a result, the best estimation of X 306 given \hat{X}₁ 340 and Y, can be given by:

\hat{X}₀=aY+b\hat{X}₁ (4)

where a and b are estimation weights:

a=D₁/(D₁+π_{N}²), and (5)

b=σ_{N}²(D₁+σ_{N}²) (6)

Referring back to FIG. 3, according to a particular non-limiting embodiment, a codec as described above with reference to FIG. 3 can be implemented as a HB video coder/decoder for performance comparison on QCIF video sequences under standard test conditions (e.g., using the eighth frame as a Key frame, and where the remaining frames are HB frames). In the below comparisons of the particular embodiment described herein, the first 100 odd frames of QCIF sequences ‘Salesman’, ‘Foreman’, ‘Mobile’, and ‘Paris’ at 15 frames per second (fps) were tested. Furthermore, the particular embodiment can encode a Key frame to an I frame, with a fixed quantization parameter, using a standard H263+ codec. For encoding a HB frame X 306, an 8×8 DCT 310 can be followed by quantization 312 and entropy coding 314 (e.g., similar to H263+). Additionally, D₁ for every slice can comprise 11 macroblocks coded in SNR format (e.g., 10 log₁₀(D₁)) by differential pulse code modulation (DPCM) with 3 bits uniform quantizer with Quantization Parameter (QP) step size of 1.0 dB and coded by fixed length coding (FLC). As a result, the difference of D₁ (in SNR format) from a neighbor slice can be quantized 312 and clipped into the range −4.0 dB to approximately +4.0 dB, and quantized 312 with maximum distortion of 0.5 dB (e.g., roughly 1.12 times).

Advantageously, D₁ 322 can be coded by FLC rather than variable length coding (VLC) 314 to minimize coder complexity, because bit rate is relatively insignificant (e.g., 0.42 kb/s) compared with the bit rate for the coefficients. In addition, in the performance comparison simulations, only D₁ 322 for the luminance component was transmitted, while at the decoder side, only estimation weights a and b of luminance component was calculated, because the chrominance component (e.g., Cb and Cr) can copy the luminance weights.

According to further non-limiting embodiments of the invention, a last frame at the encoder 302 side can be used as a prediction of current frame in a ‘zero motion’ way (e.g., where only the residual frame is coded) to achieve higher RD performance. Advantageously, the subtraction can be performed in the transform domain, thereby eliminating the need and associated coder complexity in performing inverse DCT (IDCT) at the encoder side 302. As a result, the encoder 302 can store the reconstruction coefficients at 316 for the last frame and use them as a prediction for the coefficients of the current frame. It should be understood that the particular embodiment is similar to a H263 intraframe encoder. However, relevant differences are that the quantization noise variance D₁ can be coded, and the residue coefficients rather than the coefficient itself can be coded according to various embodiments. Advantageously, the various embodiments of the encoder can be only slightly more complex than the aforementioned intraframe encoder (e.g., by a dequantization module 320, and a MSE module 318). Moreover, because the particular embodiment eliminates the IDCT at the encoder, the complexity is less than that of a comparable ‘zero motion’ P-frame encoder.

Referring again to FIG. 3, according to a further non-limiting embodiment, at the decoder side 304, a coarse reconstruction \hat{X}₁ 340 can be decoded prior to determining an 8×8 integer pixel motion estimation at 338, which can be performed in a last reconstruction frame \hat{X}*₀ 336 while treating \hat{X}₁ 340 as a current frame. After a motion compensated frame Y is determined at 334, a best guess of X 306 given \hat{X}₁ 340 and Y can be calculated as given by Eqn. 4. In addition, the particular non-limiting embodiment can advantageously perform this calculation, for each 8×8 block, in the spatial domain rather than DCT transform domain, in order to further minimize decoder computational complexity. This result follows from the observation that a and b are fixed for whole block and a DCT transform is a linear transform. As a result, this feature of various embodiments saves decoder complexity while maintaining rate-distortion performance.

It should be understood that motion vectors obtained on the basis on \hat{X}₁ 340 may not be optimal when D₁=E[(\hat{X}₁−X)²] is high. According to further non-limiting embodiments, a motion field filter can facilitate refining the motion vectors obtained from motion estimation. For example, when calculating sum of square error (SSE), pixels in current block in addition to pixels in neighboring blocks can be considered. As a result, the new SSE of current block (i,j) can be determined from the weighted average of the current block and its four neighboring blocks:

$${SSE}_{i , j}^{′} ( x , y ) = λ * {SSE}_{i , j} ( x , y ) + ( 1 - λ ) * {Avg ( {SSE}_{m , n} ( x , y ) )}_{( m , n ) ∈ NeighbourBlock ( i , j )} \qquad ( 7 )$$

where λ is the weight of current block (e.g., in the simulations λ=0.75).

Compared with conventional distributed video coding schemes based on a WZ coder, various embodiments of the invention advantageously provide coders having reduced computational complexity in both the encoder and decoder side. This follows due to the fact that such WZ coder implementations require binarization and channel coding (e.g., Turbo, LDPC, etc.), which can substantially increase encoder complexity due to the substantial amount of bit operations required. Moreover, at the decoder side, the reduced complexity advantages of the present invention is even more apparent. For example, various embodiments of the present invention avoids the significant computational complexity of the channel code decoder. Additionally, various embodiments of the present invention provide the advantage of complexity scalability in that minimally capable devices can even decode a coarse reconstruction frame.

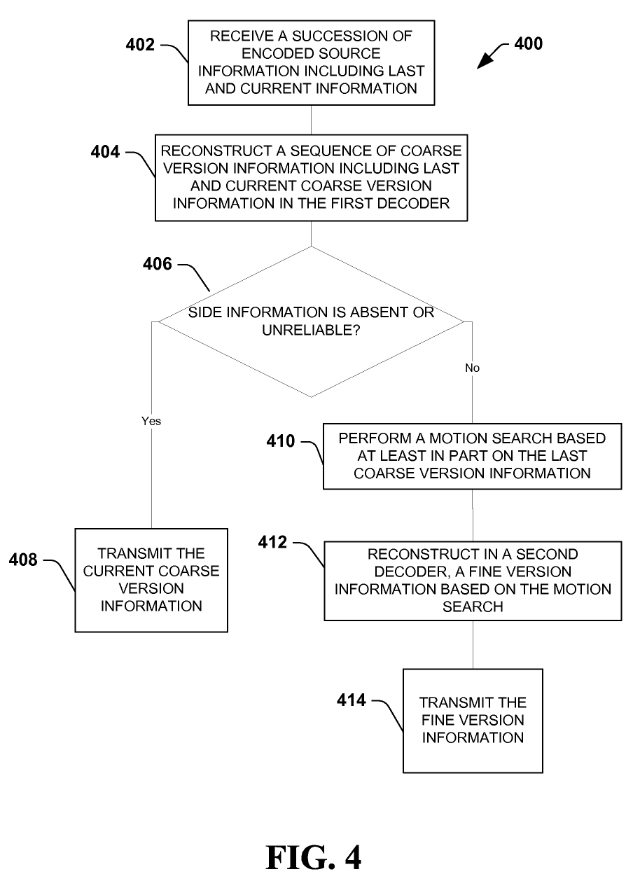

FIG. 4 illustrates an exemplary non-limiting block diagram of a method for HB coding. According to various embodiments, a first decoder can receive a succession of encoded source information including last and current information from an encoder at 402. At 404, a sequence of coarse version information including last and current coarse version information can be reconstructed a in the first decoder. At 406, depending on the determination of whether side information is available at a second encoder, the current coarse version information can be transmitted at 408. Otherwise, at 410 a motion search is performed based on the last coarse version information, which in turn is used to reconstruct a fine version information in the second decoder at 412 based on the motion search. The fine version information is then transmitted at 414. As described in further detail below, various modifications are possible according to system design considerations (e.g., RD performance, coder complexity, etc). For example, the fine version information reconstruction can be performed in the spatial domain (e.g., the same as the source data 306 in contrast to a transform domain). In addition, a fixed length coded quantization noise variance can be received from the encoder to facilitate the fine version information reconstruction.

As a further example, the encoder can include a lossy coder communicatively coupled to a quantization noise variance estimator that performs linear minimum mean square error computation and a transform module (e.g., a DCT and the like). Moreover, the lossy coder can comprise quantization and entropy coding (e.g., Huffman coding, arithmetic coding, and static coding, etc.), where data associated with the last encoded source information can be stored in the transform domain, to facilitate determining a prediction of the current encoded source information in the encoder. Alternatively, the encoder can comprise successive refinement encoding schemes based at least in part on second decoder side information being provided to the encoder.

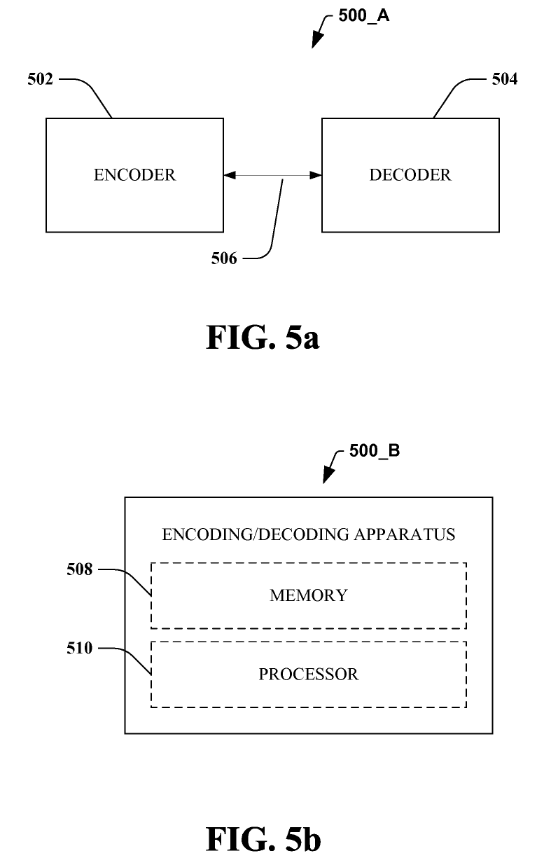

FIG. 5a illustrates an exemplary high-level block diagram of a system for coding and decoding according to one aspect of the present invention. The system of FIG. 5a comprises an encoder component 502 and a decoder component 504 communicatively coupled over a channel 506 (e.g., real or virtual, wired or wireless, and/or the like or any combination thereof). As can be appreciated, information or data transmitted over channel 506 is subject to losses or interference, which can result in coding and/or decoding errors or failures (e.g., resulting from loss or degradation of side information, interruption of a direct or feedback channel, etc.) as described above. According to various embodiments of the invention, a first decoder component can be configured to receive coded source data from an encoder component including current and prior coded data segments and produce coarse version decoded data including a current and prior coarse version data segments. Additionally, a motion prediction component can be configured to provide a motion prediction based at least in part on a prior coarse version data segment, and which can be provided to a second decoder component. The second decoder component can be configured to produce fine version decoded data based at least in part on the motion prediction in the spatial domain. Depending on whether side information is available and reliable or otherwise, the transmission component can be configured to transmit either the fine or the coarse version decoded data, respectively. As should be understood, the various modifications and alternative configurations described above with reference to FIG. 4 can also be implemented in the system of FIG. 5a according to techniques available to those skilled in the art.

FIG. 5b illustrates an exemplary non-limiting block diagram of an apparatus 500_B for coding and decoding a video sequence according to one aspect of the present invention. The apparatus 500_B can be an encoder or a portion thereof or decoder or a portion thereof as described with reference to FIGS. 1-3 and 6a-b. Apparatus 500_B can include a memory 508 that retains various instructions with respect to encoding, decoding, quantization and dequantization, and/or the like. For instance, if apparatus 500_B is an encoder as described above in connection with FIGS. 1-3 and 6a-b, memory 508 can include instructions for retrieving or receiving data to be encoded and transmitting or storing encoded data (e.g., storing reconstructed frames for future reference such as for motion compensation). Further, memory 508 can comprise instructions for performing various transforms (e.g., DCT, modified DCT, wavelet compression, Fourier transforms, and the like) Memory 508 can further include instructions for quantization and dequantization, mean square error processing, linear minimum mean square error estimation, and the like. In addition, memory 508 can retain instructions for facilitating various entropy encoding techniques as known in the art. By way of illustration and not limitation, such entropy encoding techniques can comprise Huffman coding, arithmetic coding, static coding including universal and Golomb coding, or other suitable FLC or VLC techniques, and the like. Further, memory 508 can comprise instructions for performing various statistical or inferential methods or algorithms as part of or incident to the encoding algorithms of the present invention. For example, memory 508 can store instructions or data (e.g., coefficients) for motion prediction, etc. The above example instructions and other suitable instructions can be retained within memory 508, and a processor 510 can be utilized in connection with executing the instructions.

Also, as stated above, apparatus 500_B can be an decoder or a portion thereof or decoder or a portion thereof as described with reference to FIGS. 1-3 and 6a-b. For instance, if apparatus 500_B is a decoder as described above in connection with FIGS. 1-3 and 6a-b, memory 508 can include instructions for retrieving or receiving data to be decoded and transmitting or storing decoded data (e.g., storing reconstructed frames for future reference such as for motion compensation, etc.). Further, memory 508 can comprise instructions for performing various inverse transforms (e.g., inverse DCT, inverse Fourier transforms, and the like) Memory 508 can further comprise instructions for quantization and dequantization, mean square error processing, motion estimation and compensation, linear minimum mean square error estimation, and the like. In addition, memory 508 can comprise instructions for facilitating various entropy decoding techniques as known in the art. Further, memory 508 can comprise instructions for performing various statistical or inferential methods or algorithms as part of or incident to the decoding algorithms of the present invention. The above example instructions and other suitable instructions can be retained within memory 508, and a processor 510 can be utilized in connection with executing the instructions.

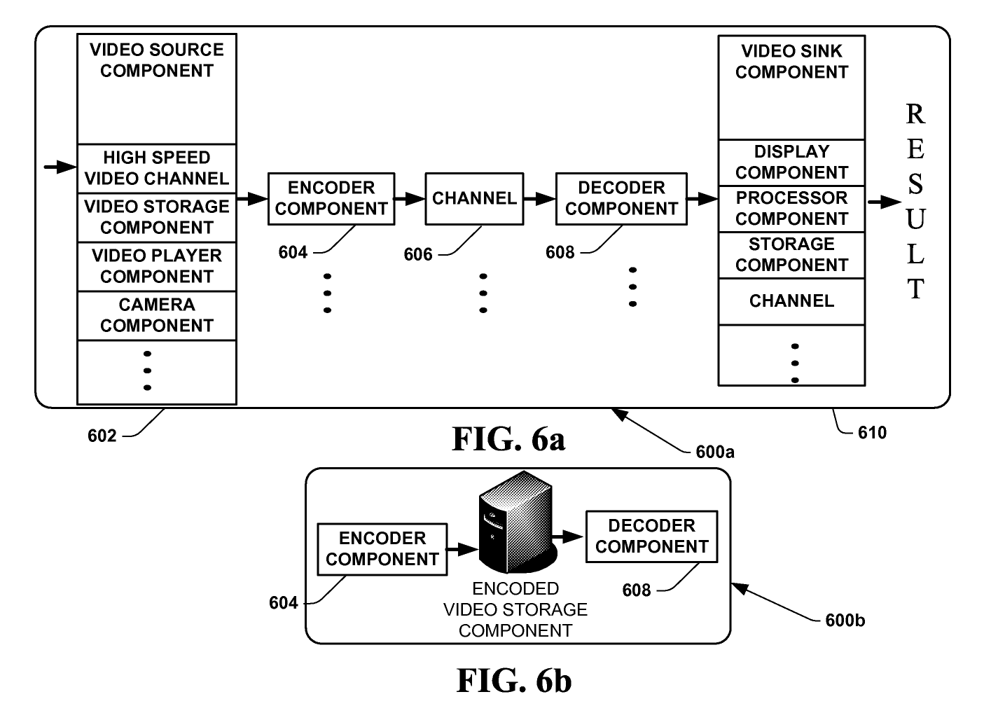

FIG. 6 is a block diagram of an exemplary non-limiting block diagram of a video coding and decoding system 600a and 600b suitable for practicing the present invention. The system accepts video data from any number of source components 602, encodes it using an encoder component 604 such that the video data is encoded for transport or storage. System 600a includes a decoder component 608 that receives the transported or stored video data and decodes it for use by any number of video sink components.

In a basic operation, video data, typically unencoded video data, is provided to encoder component 604, which encodes the video data, typically to form compressed video data that occupies fewer bits than the uncompressed video data, which then makes the compressed video data available to the decoder component (via a channel 606, storage component, or a combination thereof). The decoder component 608 in turn decompresses the compressed video data produce a substantially exact or approximate representation of the uncompressed video data provided to the input of the encoder component 604.

Video source components can include, for example, include a high-speed video channel (e.g., a cable or broadcast link capable of transmitting unencoded or partially encoded video data, video storage component (e.g., storage of unencoded or partially encoded video data), a camera component, or a video player component (e.g., a VCR or DVD player. Possible video sinks, for example, could include a display component (e.g., a monitor, television, a device LCD screen), a video processor component (e.g., video capture device, video processor algorithms operating on a special or general purpose processor, video editing device), video storage component that can store encoded or decoded video data, or another channel for subsequent transmission.

FIG. 6a illustrates an example 600a where video is encoded for transmission over a channel 606. By way of example, channel 606 could be a digital subscriber line (DSL), a cable modem, a dialup connection, broadcast, cable broadcast, satellite transmission, 802.11 Wireless link, cellular phone data network, internal signal bus, direct cable link (e.g., USB or IEEE-1394 or FIREWIRE link, and the like), or any other link (e.g., wired or wireless) suitable for the transmission of video data. In such cases, the video is encoded so that it can be transmitted using available bandwidth efficiently. For the purpose of the present invention, the channel 606 is subject to conditions presumed to cause frame loss transmission errors, which can be concealed using the disclosed systems and methods.

FIG. 6b illustrates an example of a system 600b where video is encoded for storage. As shown, encoder 604 encodes video data for storage in encoded video storage component for later retrieval by decoder 608. The encoded video storage component can take any suitable form of sufficient capacity (e.g., a memory card, a personal video recorder (PVR), a hard disk drive, RAM, DVD, CD, or any other suitable storage).

It is to be understood that the coding and decoding system is illustrated generally to understand the basic operation of the present invention. As such, the system depiction should not be viewed as limiting the claimed invention. Further to the point and as more fully described below, although components are shown on the figures as discrete blocks, any number of such components may be combined into a single device, integrated into a single multi-function chip, or distributed across multiple local or remote devices as the designer desires or as the system architecture requires without changing the nature and operation of the claimed invention.

Heegard-Berger Distributed Video Coding Results

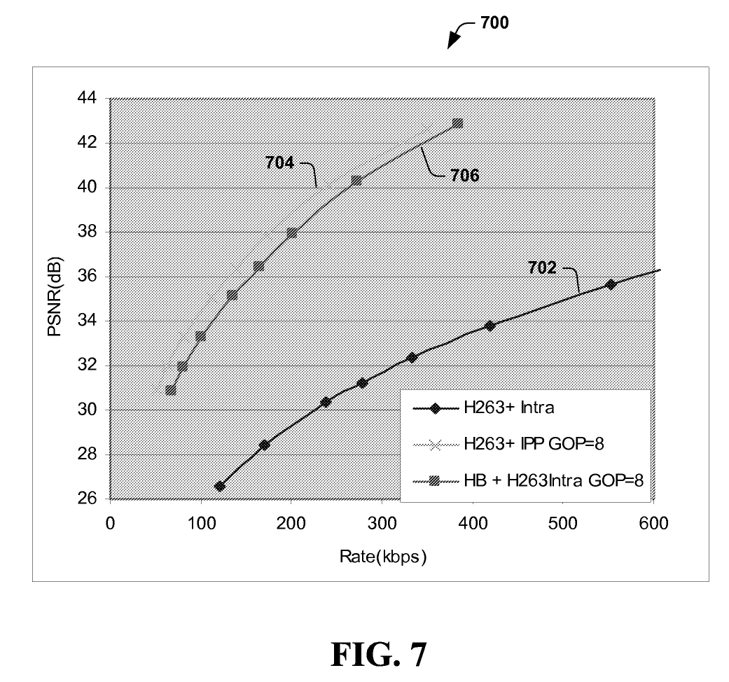

FIGS. 7-10 depict comparative RD performance for QCIF input video sequences (‘Salesman, ‘Foreman’, ‘Mobile’, and ‘Paris’) according to particular non-limiting embodiments of the present invention. In order to provide a better understanding of the advantages described with reference to FIGS. 7-10, the following abbreviations are used herein: Group of Pictures (GOP); interframe predictive coding GOP structure I-P-P (IPP); intraframe coding (Intra); interframe coding (Inter); and second edition of the ITU-T H.263 international video coding standard (H.263+). As described above, HB video coder/decoder test conditions used the eighth frame as a Key frame, and the remaining frames are HB frames. In the comparisons of the particular embodiment described supra, the first 100 odd frames of QCIF sequences ‘Salesman’, ‘Foreman’, ‘Mobile’, and ‘Paris’ at 15 frames per second (fps) were tested. Furthermore, the particular embodiment have been described encoding a Key frame to an I frame, with a fixed quantization parameter, using a standard H263+ codec.

As can be observed from FIGS. 7-10, when the RD performance of the particular embodiment of the HB frame codec is compared with the latest WZ frame codecs, the performance of this HB frame codec is comparable to state-of-the-art WZ video codecs. FIG. 7 depicts comparative RD performance for QCIF input video sequence (‘Salesman’), according to particular non-limiting embodiments of the present invention. In this video sequence, the HB codec 706 outperforms those WZ video codecs 702 more than 1 dB at all bit rates, and approaches the H263+ interframe codec 704.

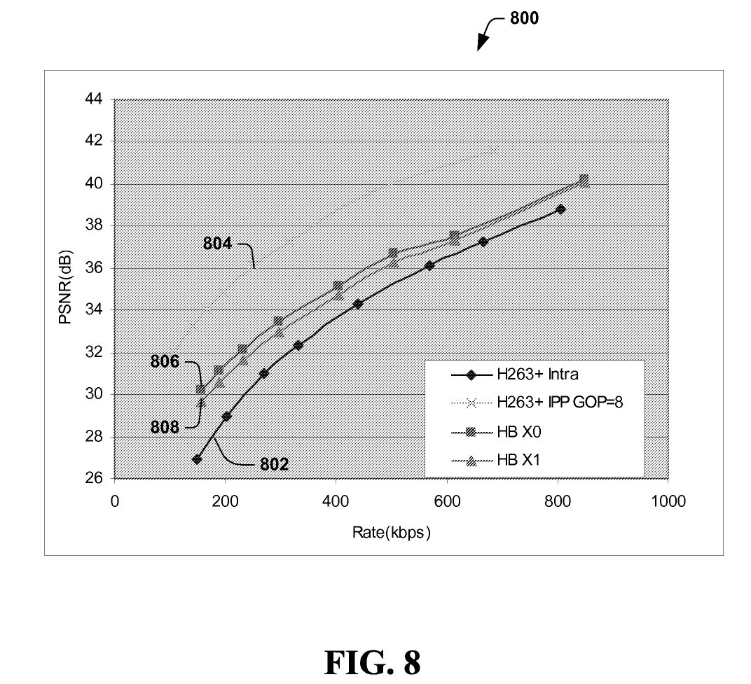

FIG. 8 depicts comparative RD performance for QCIF input video sequence (‘Foreman’), according to particular non-limiting embodiments of the present invention. Accordingly, in this video sequence, the HB codec 806, 808 outperformed those WZ video codecs 802 at low bit rate but was outperformed by some of them at high bit rate. This results because the HB code benefits from more accurate motion compensation, by using more bits in the determination of \hat{X}₁, the coarse reconstruction frame, than those WZ coders use in the hash.

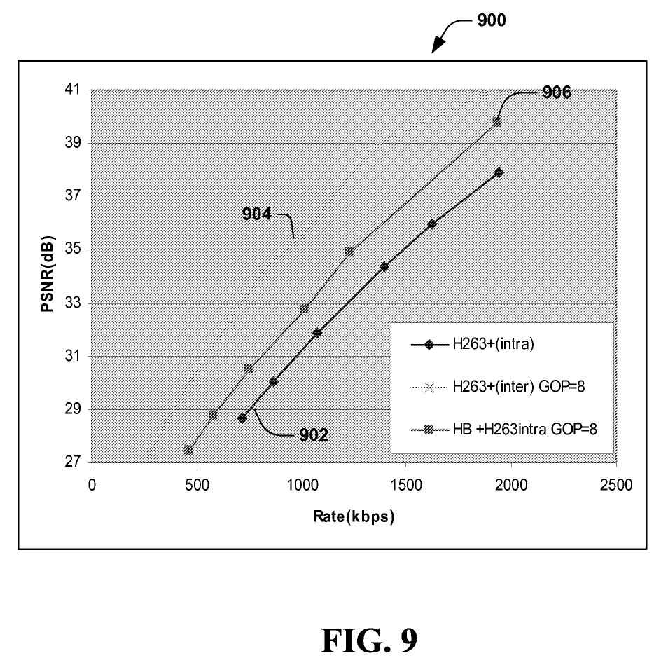

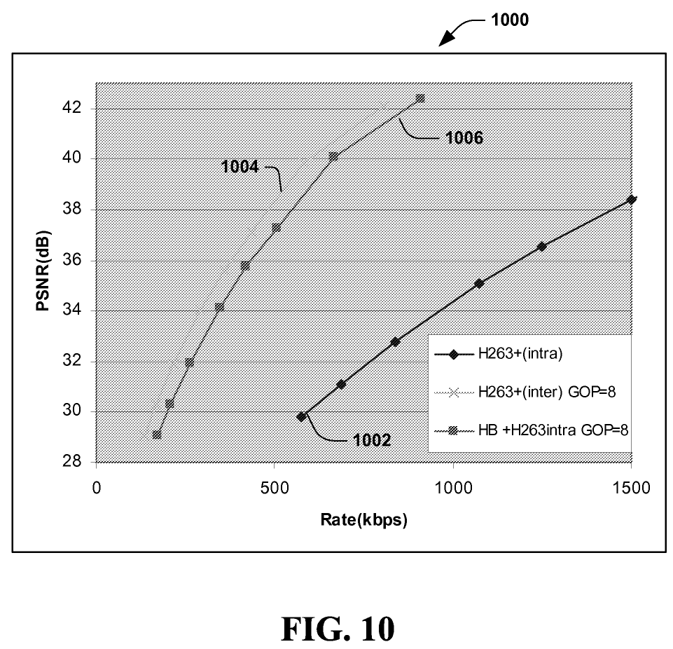

FIG. 9 depicts comparative RD performance for QCIF input video sequence (‘Mobile’) according to particular non-limiting embodiments of the present invention. FIG. 10 depicts comparative RD performance for QCIF input video sequence (‘Paris’) according to particular non-limiting embodiments of the present invention. Regarding the distortion gap between \hat{X}₀ and \hat{X}₁, if Y is not available (e.g., no motion estimation performed at the decoder side), the loss (difference of D₁ and D₀ in PSNR) is up to 0.6 dB for low bit rate and down to 0.2 dB for high bit rate on the sequences ‘Foreman’ (FIG. 8) and ‘Mobile’ (FIG. 9). Similarly, the loss is near 0 dB for the sequences ‘Salesman’ (FIG. 7) and ‘Paris’ (FIG. 10). This indicates that for low motion video sequences, because residual coefficient coding is sufficient, motion estimation at decoder side can provide only minimal improvement.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with coding and decoding systems and methods in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes. Digital video processing, and thus the techniques for coding and decoding in accordance with the present invention can be applied with great efficacy in those environments.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods of coding and decoding of the invention.

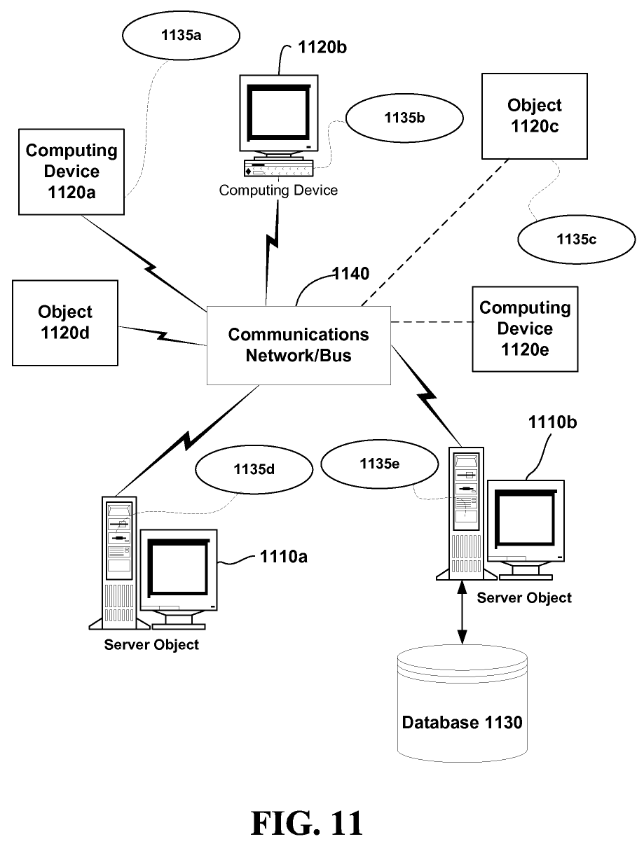

FIG. 11 provides a schematic diagram of an exemplary networked or distributed computing environment. The distributed computing environment comprises computing objects 1110a, 1110b, etc. and computing objects or devices 1120a, 1120b, 1120c, 1120d, 1120e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1140. This network may itself comprise other computing objects and computing devices that provide services to the system of FIG. 11, and may itself represent multiple interconnected networks. In accordance with an aspect of the invention, each object 110a, 1110b, etc. or 1120a, 1120b, 1120c, 1120d, 1120e, etc. may contain an application that might make use of an API, or other object, software, firmware and/or hardware, suitable for use with the systems and methods for coding and decoding in accordance with the invention.

It can also be appreciated that an object, such as 1120c, may be hosted on another computing device 1110a, 1110b, etc. or 1120a, 1120b, 1120c, 1120d, 1120e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to coding and decoding data according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 11, as an example, computers 1120a, 1120b, 1120c, 1120d, 1120e, etc. can be thought of as clients and computers 1110a, 1110b, etc. can be thought of as servers where servers 1110a, 1110b, etc. maintain the data that is then replicated to client computers 1120a, 1120b, 1120c, 1120d, 1120e, etc., although any computer can be considered a client, a server, or both, depending on the circumstances. Any of these computing devices may be processing data or requesting services or tasks that may implicate the coding and decoding systems and methods in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for coding and decoding of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 11 illustrates an exemplary networked or distributed environment, with server(s) in communication with client computer (s) via a network/bus, in which the present invention may be employed. In more detail, a number of servers 1110a, 110b, etc. are interconnected via a communications network/bus 1140, which may be a LAN, WAN, intranet, GSM network, the Internet, etc., with a number of client or remote computing devices 1120a, 1120b, 1120c, 1120d, 1120e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to code and decode data according to the disclosed compression systems and methods.

In a network environment in which the communications network/bus 1140 is the Internet, for example, the servers 1110a, 1110b, etc. can be Web servers with which the clients 1120a, 1120b, 1120c, 1120d, 1120e, etc. communicate via any of a number of known protocols such as HTTP. Servers 1110a, 1110b, etc. may also serve as clients 1120a, 1120b, 1120c, 1120d, 1120e, etc., as may be characteristic of a distributed computing environment.

As mentioned, communications may be wired or wireless, or a combination, where appropriate. Client devices 1120a, 1120b, 1120c, 1120d, 1120e, etc. may or may not communicate via communications network/bus 1140, and may have independent communications associated therewith. For example, in the case of a TV or VCR, there may or may not be a networked aspect to the control thereof. Each client computer 1120a, 1120b, 1120c, 1120d, 1120e, etc. and server computer 1110a, 1110b, etc. may be equipped with various application program modules or objects 1135a, 1135b, 1135c, etc. and with connections or access to various types of storage elements or objects, across which files or data streams may be stored or to which portion(s) of files or data streams may be downloaded, transmitted or migrated. Any one or more of computers 1110a, 1110b, 1120a, 1120b, 1120c, 1120d, 1120e, etc. may be responsible for the maintenance and updating of a database 1130 or other storage element, such as a database or memory 1130 for storing data processed or saved according to the invention. Thus, the present invention can be utilized in a computer network environment having client computers 1120a, 1120b, 1120c, 1120d, 1120e, etc. that can access and interact with a computer network/bus 1140 and server computers 1110a, 1110b, etc. that may interact with client computers 1120a, 1120b, 1120c, 1120d, 1120e, etc. and other like devices, and databases 1130.

### Exemplary Computing Device

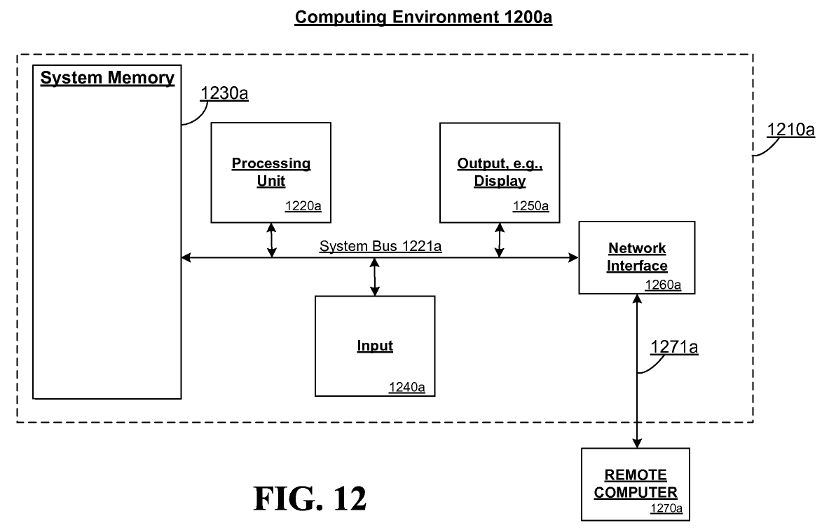

As mentioned, the invention applies to any device wherein it may be desirable to code and decode data. It should be understood, therefore, that handheld, portable and other computing devices and computing objects of all kinds are contemplated for use in connection with the present invention, i.e., anywhere that a device may receive or otherwise process or store data code and/or decode data (e.g., video data). Accordingly, the below general purpose remote computer described below in FIG. 12 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200a in which the invention may be implemented, although as made clear above, the computing system environment 1200a is only one example of a suitable computing environment for a media device and is not intended to suggest any limitation as to the scope of use or functionality of the invention. Neither should the computing environment 1200a be interpreted as having any dependency or requirement relating to any one or combination of components illustrated in the exemplary operating environment 1200a.

With reference to FIG. 12, an exemplary remote device for implementing the invention includes a general purpose computing device in the form of a computer 1210a. Components of computer 1210a may include, but are not limited to, a processing unit 1220a, a system memory 1230a, and a system bus 1221a that couples various system components including the system memory to the processing unit 1220a. The system bus 1221a may be any of several types of bus structures including a memory bus or memory controller, a peripheral bus, and a local bus using any of a variety of bus architectures.

Computer 1210a typically includes a variety of computer readable media. Computer readable media can be any available media that can be accessed by computer 1210a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210a. Communication media typically embodies computer readable instructions, data structures, program modules or other data in a modulated data signal such as a carrier wave or other transport mechanism and includes any information delivery media.

The system memory 1230a may include computer storage media in the form of volatile and/or nonvolatile memory such as read only memory (ROM) and/or random access memory (RAM). A basic input/output system (BIOS), containing the basic routines that help to transfer information between elements within computer 1210a, such as during start-up, may be stored in memory 1230a. Memory 1230a typically also contains data and/or program modules that are immediately accessible to and/or presently being operated on by processing unit 1220a. By way of example, and not limitation, memory 1230a may also include an operating system, application programs, other program modules, and program data.

The computer 1210a may also include other removable/non-removable, volatile/nonvolatile computer storage media. For example, computer 1210a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221a through a non-removable memory interface such as an interface, and a magnetic disk drive or optical disk drive is typically connected to the system bus 1221a by a removable memory interface, such as an interface.

A user may enter commands and information into the computer 1210a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1220a through user input 1240a and associated interface(s) that are coupled to the system bus 1221a, but may be connected by other interface and bus structures, such as a parallel port, game port or a universal serial bus (USB). A graphics subsystem may also be connected to the system bus 1221a. A monitor or other type of display device is also connected to the system bus 1221a via an interface, such as output interface 1250a, which may in turn communicate with video memory. In addition to a monitor, computers may also include other peripheral output devices such as speakers and a printer, which may be connected through output interface 1250a.

The computer 1210a may operate in a networked or distributed environment using logical connections to one or more other remote computers, such as remote computer 1270a, which may in turn have media capabilities different from device 1210a. The remote computer 1270a may be a personal computer, a server, a router, a network PC, a peer device or other common network node, or any other remote media consumption or transmission device, and may include any or all of the elements described above relative to the computer 1210a. The logical connections depicted in FIG. 12 include a network 1271a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1210a is connected to the LAN 1271a through a network interface or adapter. When used in a WAN networking environment, the computer 1210a typically includes a communications component, such as a modem, or other means for establishing communications over the WAN, such as the Internet. A communications component, such as a modem, which may be internal or external, may be connected to the system bus 1221a via the user input interface of input 1240a, or other appropriate mechanism. In a networked environment, program modules depicted relative to the computer 1210a, or portions thereof, may be stored in a remote memory storage device. It will be appreciated that the network connections shown and described are exemplary and other means of establishing a communications link between the computers may be used.

Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for coding and/or decoding in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for data coding and decoding of the invention. The invention contemplates the use of the invention from the standpoint of an API (or other software object), as well as from a software or hardware object that performs coding and decoding in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As mentioned above, while exemplary embodiments of the present invention have been described in connection with various computing devices and network architectures, the underlying concepts may be applied to any computing device or system in which it is desirable to code and/or decode data. For instance, the systems and methods of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the coding and decoding methods of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described sura, methodologies that may be implemented in accordance with the disclosed subject matter will be better appreciated with reference to the flowcharts of FIGS. 1-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments may refer to utilizing the present invention in the context of particular programming language constructs, the invention is not so limited, but rather may be implemented in any language to provide methods for coding and decoding. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A decoding method comprising:
receiving in a first decoder a succession of encoded source information including last and current information from an encoder;
reconstructing a sequence of coarse version information including last and current coarse version information in the first decoder;
determining whether side information is absent or substantially unreliable;
transmitting the current coarse version information if side information is absent or substantially unreliable; otherwise
performing a motion search based at least in part on the last coarse version information;
reconstructing in a second decoder for the current version information from the encoder, a fine version information based at least in part on the motion search, the second decoder having a spatial domain; and
transmitting the fine version information.

2. The method of claim 1, wherein the fine version information reconstruction is performed in the spatial domain.

3. The method of claim 1, further comprising:
receiving in the second decoder a coded quantization noise variance from the encoder to facilitate the fine version information reconstruction.

4. The method of claim 3, wherein the quantization noise variance from the encoder is coded using fixed length coding.

5. The method of claim 3, wherein the encoder includes a lossy coder communicatively coupled to a quantization noise variance estimator and a transform module having a transform domain.

6. The method of claim 5, further comprising performing linear minimum mean square error computation in the estimator to facilitate quantization noise variance estimation.

7. The method of claim 5, further comprising:
performing quantization and entropy coding in the lossy coder to facilitate producing the succession of encoded source information.

8. The method of claim 5, further comprising:
storing in the transform domain, data associated with the last encoded source information to facilitate determining a prediction of the current encoded source information in the encoder.

9. The method of claim 7, wherein the entropy coding is one of Huffman coding, arithmetic coding, and static coding.

10. The method of claim 2, wherein the encoder includes successive refinement encoding based at least in part on second decoder side information communicatively coupled to the encoder.

11. A decoding system comprising:
a first decoder component configured to receive coded source data from an encoder component including current and prior coded data segments and produce coarse version decoded data including a current and prior coarse version data segments;
a motion prediction component configured to provide a motion prediction based at least in part on a prior coarse version data segment;
a second decoder component configured to produce fine version decoded data based at least in part on the motion prediction in the spatial domain; and
a transmission component configured to transmit either the fine or the coarse version decoded data, respectively depending on whether side information is available and reliable or otherwise.

12. The system of claim 11, wherein the second decoder component is further configured to receive a fixed length coded quantization noise variance from the encoder component to facilitate producing the fine version decoded data.

13. The system of claim 12, wherein the encoder component comprises a lossy coding component communicatively coupled to a quantization noise variance estimation component and a transform component having a transform domain to facilitate producing the coded source data.

14. The system of claim 13, wherein the quantization noise variance estimation component is configured to perform linear minimum mean square error computation to facilitate quantization noise variance estimation.

15. The system of claim 13, wherein the lossy coding component further comprises a quantization component and an entropy coding component, the lossy coding component is further configured to store information associated with the prior coded data segments in the transform domain to facilitate determining a prediction of the information associated with the current coded data segment.

16. In a video coding system, a coding method comprising:
encoding source data to form encoded source data to facilitate first-pass decoding by a first decoder, wherein the encoded source data includes a prior-pass and a current-pass encoded source data, and wherein the first-pass decoding produces first-pass decoded data for the prior-pass and the current-pass encoded source data; and
encoding quantization noise variance in an estimator module to form a coded quantization noise variance to facilitate second-pass decoding by a second decoder based on second decoder side information, wherein the second decoder side information is based in part on the first-pass decoded data for prior-pass encoded source data.

17. The method of claim 16, wherein the encoding in the estimator module includes performing linear minimum mean square error determination to facilitate encoding the quantization noise variance.

18. The method of claim 16, wherein the encoding source data includes encoding in a lossy coder communicatively coupled to the estimator module and storing in a transform domain of the lossy coder data associated with the prior-pass encoded source data to facilitate determining a prediction of data associated with the current-pass encoded source data.

19. The method of claim 18, further comprising:
performing entropy coding after quantization in the lossy coder to facilitate first-pass decoding by the first decoder.

20. The method of claim 16, wherein the encoding source data includes successive refinement encoding based at least in part on the second decoder side information received from the second pass decoder.
